(19) United States
(12) Patent Application Publication
(10) Pub. No.: US 2014/0188992 A1
(43) Pub. Date: Jul. 3, 2014

(54) FACILITATING SOCIAL NETWORKING INTERACTION ACROSS A TIME AXIS

(71) Applicant: Google Inc., (US)

(72) Inventor: Dilan JAYAWARDANE, San Francisco, CA (US)

(73) Assignee: Google Inc., Mountain View, CA (US)

(21) Appl. No.: 13/728,941

(22) Filed: Dec. 27, 2012

(51) Int. Cl. H04L 29/06

(52) U.S. Cl. CPC H04L 65/403
USPC 709/204

(57) ABSTRACT

In one aspect, a method includes receiving an indication of a request from a user to generate a time-based social networking session at a social networking service, determining an instance of time associated with the request, the instance of time being distinct from the current time, identifying social network state information corresponding to the instance of time, the social network state information including social graph information regarding the state one of a social graph at the given instance of time and generating a social networking session according to the social network state information, the social networking session providing the user with a social networking experience according to the state of the social network of the user at the instance of time.

### BACKGROUND

Social networks may be arranged in a flat graph structure. For example, a social graph is maintained by a social networking service indicating a one-to-one relationship among users (e.g., a friend/follower network). Each node of the graph represents a connection between two individuals. At any given time, the graph represents a cross section snapshot of the relationships among the social network users.

### SUMMARY

The disclosed subject matter relates to a machine-implemented method including receiving an indication of a request from a user to generate a time-based social networking session associated with a social networking service. The method further including determining an instance of time associated with the request, the instance of time being distinct from the current time. The method further including identifying social network state information corresponding to the instance of time, the social network state information including social graph information regarding the state of a social graph at the given instance of time and generating a social networking session according to the social network state information, the social networking session providing the user with a social networking experience according to the state of the social network of the user at the instance of time.

Other aspects can be embodied in corresponding systems and apparatus, including computer program products. These and other aspects can include one or more of the following features. The social graph information may include a snap shot of the at least one social graph at an instance of time, the instance of time being proximate to the instance of time. The social graph information may include event information corresponding to one or more changes or modifications of the connections between the user and one or more other users of the social networking service within the social graph. The social graph information may include information corresponding to one or more user connections within the social graph generated at a point before the instance of time. The social network state information may include one or more user preferences or settings regarding the social networking service specified by the user at the instance of time.

Generating a social networking experience may include generating a social graph according to the social graph information corresponding to the connections between the user and one or more other users of the social networking service at the instance of time. The method may further include providing the social networking experience for display to the user, in response to the request. The method may further include receiving an indication of user activity at the social networking session and performing the user activity according to the social network state information. Performing the user activity according to the social network state information may cause the activity to be performed according to one or more of settings, preferences and the social graph of the user at the instance of time. The social networking session is further generated based on one or more current privacy information. The privacy information may provide one or more modifications to the social network state information according to privacy modifications made after the instance of time.

The disclosed subject matter also relates to a system including one or more processors and a machine-readable medium including instructions stored therein, which when executed by the processors, cause the processors to perform operations including receiving a request from a user a social networking service to generate a time-based social networking session corresponding to an instance of time different from the current time, the social networking service maintaining a social graph corresponding to the user. The operations further including identifying social network state information corresponding to the social network of the user at the instance of time, the social network state information including social graph information regarding a social graph representing connections between the user and one or more other users of the social networking service. The operations further including generating a social networking session according to the social network state information including generating the state of the social graph at the instance of time, the social networking session providing the user with a social networking experience according to the state of the social graph of the user at the instance of time.

Other aspects can be embodied in corresponding systems and apparatus, including computer program products. These and other aspects can include one or more of the following features. The social graph information may include a snap shot of the social graph at an instance of time, the instance of time being proximate to the instance of time. The social graph information may include events corresponding to one or more changes or modifications with respect to the social graph. The social graph information may include one or more connections within the social graph generated between the user and one or more other users of the social networking service up to the instance of time. The social network state information further may include one or more user preferences or settings regarding the social networking service at the instance of time.

Generating a social networking experience may include generating a social graph according to the social network state information corresponding to connections between the user and one or more other users of the social networking service at the instance of time. The operations may further include providing the social networking session for display to the user, in response to the request, receiving an indication of user activity with respect to the social networking session and performing the user activity according to the social network state information such that the activity is performed with respect to the state of the social network of the user at the instance of time.

The disclosed subject matter also relates to a machine-readable medium including instructions stored therein, which when executed by a machine, cause the machine to perform operations including receiving a request from a user at a social networking service to generate a time-based social networking session corresponding to an instance of time at the social networking service, the social networking service maintaining a social graph associated with the user, the social graph maintaining connections between the user and one or more other users of the social networking service. The operations further including identifying social network state information corresponding to the instance of time, the social network information including social graph information regarding the social graph and information regarding one or more user preferences and setting at the instance of time, the social graph information providing information regarding the connections between the user and one or more users associated with the user at the instance of time and generating a social networking session according to the social network state information, the social networking session providing the user with a social networking experience according to the state of the social network of the user at the instance of time.

Other aspects can be embodied in corresponding systems and apparatus, including computer program products. These and other aspects can include one or more of the following features. The operations may further include providing the social networking experience for display to the user, in response to the request, receiving an indication of user activity at the social networking service and performing the user activity according to the social networking information.

These and other features described in this section and throughout provide various advantages, including, for example, generating a third dimension within the social graph across the time axis, enabling users of the social networking services to move across the time axis, such that the user is able to interact with his/her social network as it existed at different states that are distinct from the present state of the social network.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example client-server network environment, which provides for facilitating social networking interaction across a time axis.

FIG. 2 illustrates a flow diagram of an example process for providing a user with a social networking experience at a specified time.

FIG. 3 illustrates an example social graph of a user at a first instance of time.

FIG. 4 illustrates an example graphical user interface displaying a social networking page displayed to the user and associated with a social networking session at the first instance of time.

FIG. 5 illustrates a social graph of the user at a second instance of time.

FIG. 6 illustrates an example graphical user interface displaying a social networking page displayed to the user and associated with a social networking session at the second instance of time.

FIG. 7 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent that the subject technology is not limited to the specific details set forth herein and may be practiced without these specific details.

Users of social networking services may create associations with one another. The phrase “social networking service” as used herein, includes an online service, platform or site that focuses on building and reflecting of social associations among users. These associations may be stored within a social graph at each social networking service. Such user associations may be defined on a user-to-user basis, or as a group of users associated through membership within a group. As used herein, “contacts” refer to other users that a user is associated with, at one or more social networking services.

A user may create “social groups” (e.g., social circles) including one or more contacts to organize his/her associations. The social groups may be additionally used to control distribution of messages and content to contacts of the user. For example, “social circles” are categories to which a user can assign their social networking contacts and better control the distribution and visibility of social networking messages as well as other multimedia content (e.g., documents, and other collaboration objects). In accordance with the subject disclosure, a social circle is provided as a data set defining a collection of contacts that are associated with one another. As used herein, a social circle can be described from the perspective of an individual that is the center of a particular collection of socially interconnected people, or from the aggregate perspective of a collection of socially interconnected people. In some examples, a social circle can have narrowly defined boundaries, all of the members of the social circle may be familiar with one another, and permission may be required for a member to join a social circle. In accordance with the subject disclosure, a user of an electronic device may define a social circle, and the social circle, as a data set defining a collection of contacts, may reflect a real-life social circle of the user.

For example, a user of an electronic device may have different groups of friends, coworkers, and family, and there may be some overlap among those groups (e.g., a coworker who is also considered to be a friend, a family member who is also a coworker). Through the creation and use of social groups (e.g., social circles), the user can organize and categorize his/her contacts into various different groupings.

Typically such associations are maintained in a flat graph structure. For example, a social graph maintained by a social networking service indicates a one-to-one relationship among users (e.g., a friend/follower network). Each node of the graph represents a connection between two individuals. At any given time, the graph represents a cross section snapshot of the relationships among the social network users.

The subject disclosure provides a method and system for generating a third dimension within the social graph across the time axis, enabling users of the social networking services to move across the time axis. The method allows the user to go back in time with respect to his/her social networking experience, and interact with the social network (e.g., as represented by the social graph) at various time instances. The user is able to experience his/her social network as it existed at any selected time and may interact with the social network according to the state of his/her social network (e.g., including connections reflected between the user and contacts within the social graph) at the selected time. For example, the user may perform one or more social activities such as publish posts, generate comments, endorsements and/or perform other actions, which are carried out according to the state of the social network at a selected time that may be different from the current time. Thus, the user is able to interact with his/her social network as it existed at different states that are distinct from the present state of the social network.

In one example, the system maintains data regarding the evolution of the social graph and allows users to interact with each other in a state of time of their choosing. In some examples, snapshots of the social graph are generated at regular intervals and maintained. A time stamp may be associated with each snapshot. In some examples, a record of modifications to the social network (e.g., each interaction and/or edge creation with respect to a node within the social graph, changes to user settings, preferences, etc.) may be maintained. A time stamp may be associated with each modification event with respect to the social network.

When a user, for example, logged into the social networking service, requests to access his/her social network profile at a given time (e.g., a time different from the current time), the stored data regarding the state of the social network and/or one or more modification events associated with the user (e.g., the user node within the social graph) are retrieved. Data regarding the state of the social graph at a given time may include snap shots and/or interaction events up to the identified instance of time. The information may include a snapshot of the social graph at or close to the identified instance of time and/or event information regarding the connections made up to the instance of time. The system then generates a social networking experience for the user, where the user is able to view and interact with the social network at the identified instance of time rather than being restricted to the most up to date state of the social network.

For example, where a user has added one or more contacts, preferences or setting or otherwise modified the social networking experience after an instant of time, when the user requests to interact with the social network at that instance of time, the user's interaction and view of the social network will be as if the one or more contacts, preferences, settings, etc., were not modified. In one implementation, the closest snapshot to the selected instance of time may be identified. In one example, the snapshot may further be modified based on event information regarding activity taken towards the social graph making up the difference between the time stamp of the snapshot and the selected instance of time, if such difference exists. In another example, the modification events may be used to recreate the social networking experience at the given instance of time by building the social network based on all events that occurred up to the given time (e.g., by building the state of the social network based on all events) and/or after the given time (e.g., by modifying the social network based on these events).

In one example, the experience at a given instance of time provided to a user may vary based on one or more system settings, user settings, privacy settings or user preferences. While the system may regenerate the experience of the user at some instance of time in the past, in one example, the system may make some modifications to the experience. For example, where the user removes a contact and/or is removed as contact, when the user goes back to a specific instance of time, the system may, for privacy reasons, treat the contact as being removed from the user's list of contacts, although the removal did not occur until after the identified instance of time. Furthermore, user and/or system preferences or settings before and/or after the given instance of time (e.g., security settings, privacy settings and/or preferences) may dictate how and to what extent the user's interactions are performed or propagated with respect to the identified instance of time and how such actions are reflected in present time.

Thus the system allows the user to experience a social network across a time axis without being constrained by actions taken over time up to the present.

A “social networking session” as used herein may refer to a semi-permanent interactive information interchange between the user and the social networking service, providing the user with a social networking experience. A time-based social networking session may be established upon receiving a request from a user and may terminate either after the user logs out of the social networking service and/or after the session is terminated according to a subsequent request (e.g., a user request to return to the current time or regular session, or to a different time-based session at a different instance of time). In one example, each time based session is associated with a specific instance of time, a unique social graph, and/or one or more settings or preferences which are associated with the instance of time associated with the session. When the user performs a task within the social networking session, the task is performed according to the social graph, settings and/or preferences associated with the session. In one example, one or more of the social graph, settings and preferences of a specific time-based session may be different from the state of the social graph, settings and preferences at the actual instance of time associated with the session, for example, according to later activities by the user, one or more other users, a system administrator, and/or the social networking service (e.g., for privacy or security reasons, change in system structure, change in policies, etc.).

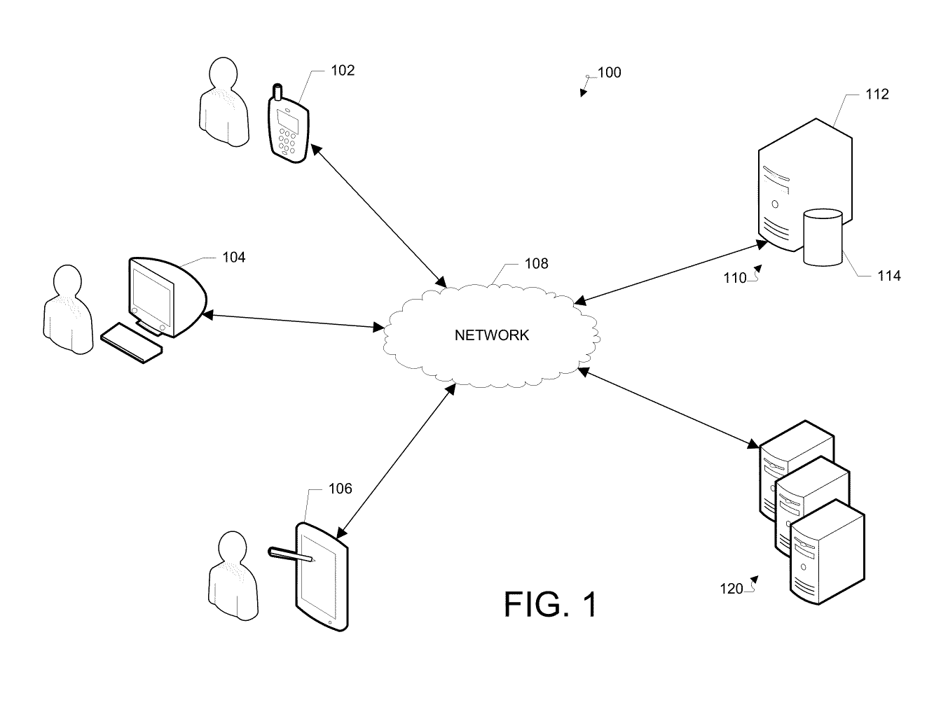

FIG. 1 illustrates an example client-server network environment, which provides for facilitating social networking interaction across a time axis. A network environment 100 includes a number of electronic devices 102, 104, 106 communicably connected to a server 110 and remote servers 120 by a network 108. Network 108 can be a public communication network (e.g., the Internet, cellular data network, dialup modems over a telephone network) or a private communications network (e.g., private LAN, leased lines). Further, network 108 can include, but is not limited to, any one or more of the following network topologies, including a bus network, a star network, a ring network, a mesh network, a star-bus network, a tree or hierarchical network, and the like.

In some example implementations, electronic devices 102, 104, 106 can be computing devices such as laptop or desktop computers, smartphones, PDAs, portable media players, tablet computers, or other appropriate computing devices. In the example of FIG. 1, electronic device 102 is depicted as a smartphone, electronic device 104 is depicted as a desktop computer and electronic device 106 is depicted as a PDA.

In some implementations, server 110 includes a processing device 112 and a data store 114. Processing device 112 executes computer instructions stored in data store 114, for example, to facilitate social networking interaction across a time axis for users interacting with electronic devices 102, 104, 106. Server 110 may further be in communication with remote servers 120 either through the network 108 or through another network or communication means.

In one example, the system may further comprise one or more other remote servers 120 performing various functionalities and/or storage capabilities described herein either alone or in combination with server 110. Server 110 and/or one or more of the remote servers 120 may further host, maintain or be in communication with one or more social networking services. The one or more social networking services may provide various services and may enable users to create a profile and associate themselves with other users at a remote social networking service. The server 110 and/or the one or more remote servers 120 may further facilitate the generation and maintenance of a social graph including the user created associations. The social graphs may include, for example, a list of all users of the remote social networking service and their associations with other users of a remote social networking service.

In some example aspects, server 110 and/or one or more remote servers 120 can be a single computing device such as a computer server. In other implementations, server 110 and/or one or more remote servers 120 can represent more than one computing device working together to perform the actions of a server computer (e.g., cloud computing). Server 110 and/or one or more remote servers 120 may be coupled with various remote databases or storage services. While server 110 and the one or more remote servers 120 are displayed as being remote from one another, it should be understood that the functions performed by these servers may be performed within a single server, or across multiple servers.

Communications between the client devices 102, 104, 106, server 110 and/or one or more remote servers 120 may be facilitated through the HTTP communication protocol. Other communication protocols may also be facilitated including for example, XMPP communication, for some or all communications between the client devices 102, 104, 106, server 110 and one or more remote servers 120 (e.g., through network 108).

Users may interact with the applications and/or services, including the one or more social networking services, hosted by server 110 and/or one or more remote servers 120, through a client application installed at the electronic devices 102, 104, 106. Alternatively, the user may interact with one or more of the services and/or applications through a web based browser application at the electronic devices 102, 104, 106. Communication between client devices 102, 104, 106 and the applications and/or services, may be facilitated through a network (e.g., network 108).

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

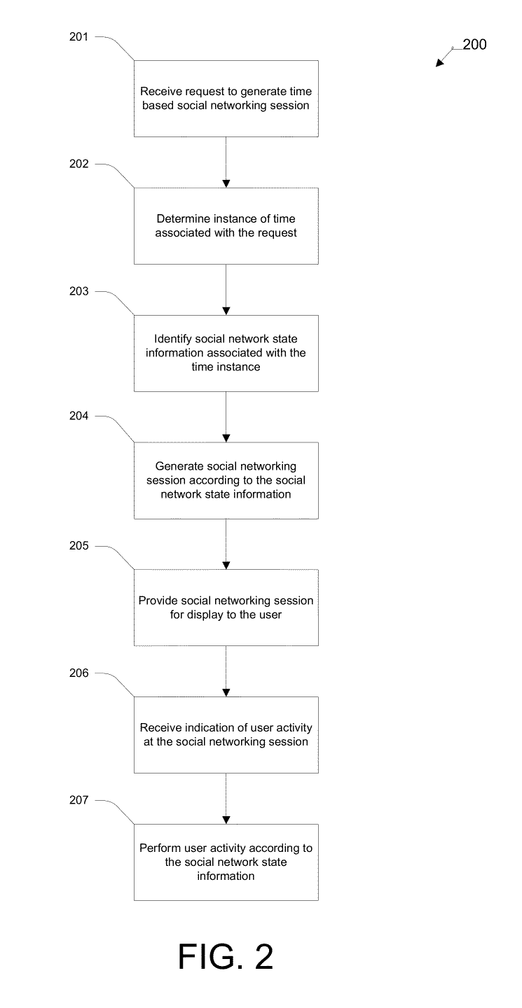

FIG. 2 illustrates a flow diagram of an example process 200 for providing a user with a social networking experience at a specified time. In step 201, a request is received to generate a time-based social networking session. In one example, the request provides a specific time for which the user wishes to view their social network. In one example, the user is logged into the system. In another embodiment, a query may be sent to the user to determine the identity of the user.

In step 202, the instance of time associated with the request is determined. As described above, the request may include a time value indicating the instance of time. In some implementations, a query may be provided to the user in response to the request, and the user may provide the desired instance of time.

In step 203, social graph state information corresponding to the specific instance of time is identified. As described above, each user is associated with a social graph showing the connections between the user and one or more contacts (e.g., as nodes within the social graph). In addition, the social graph may include other information and connections regarding the user and/or one or more contacts. In addition to the social graph, in step 203, various other sources of information regarding the social network of the user may also provide further information regarding the social network of the user. In some implementations, social network information regarding the user is maintained over time, using various techniques. In some examples, the information may be maintained through snapshots of the social network of the user (e.g., the user social graph) at various points in time. Each snap shot may be associated with a specific time stamp indicating the instance of time corresponding to the snapshot. Similarly, in one or more implementations, events corresponding to changes or modifications may be maintained as entries regarding the social network of the user, for example corresponding to activity with respect to the social network of the user, or a change or modification of the social network of the user (e.g., within the social graph or otherwise being maintained). Each event entry may be associated with a time stamp indicating the time the activity, change and/or modification occurred and/or the time when the entry was generated and or stored. Other information including various settings and preferences of the user at the specified time may also be retrieved in step 203 as social graph state information and may be used to generate the time-based social networking session.

In step 204, a time-based social networking session is generated according to the identified state information. In one example, the system generates a social network for the user representative of the state of the social network of the user at the specified time determine din step 202. In some implementations, the social network is generated using the state information such as the snapshots and/or time stamped entries regarding various activities performed with respect to the social network of the user. The system may, for example, generate a social graph for the user, the social graph representing the connections of the user at the specified time. In some example, in addition to the identified state information, other information may be considered when generating the time-based social networking session. For example, in some instances, privacy information may be considered when generating the time-based social networking session. While the time-based social networking session is generated to represent the state of the user social network at the time specified, in some examples, various modifications may be made in order to protect the privacy of the user and/or other users (e.g., contacts of the user).

In step 205, the system provides the time-based social networking session generated in step 204, for display to the user. Once the social networking session is displayed to the user (e.g., at the client device), the user may interact with the social networking session, similar to real-time sessions. In one example, the user may for example, perform various social actions (e.g., post, comment, share, and/or endorse content in the social networking session). In step 206, an indication of user activity in the social networking session is received. User activity may include various social activity including, for example, posting content, sharing and/or resharing content, commenting on content, endorsing content or other actions taken by the user with respect to the social networking session, and/or content published within or in association with the social networking service.

In step 207, the user activity is performed within the time-specific social networking session. Actions performed by the user may be carried out according to the time-based social networking session (e.g., according to the time-specific social networking, including for example the social graph or user settings/preferences) and/or according to various real-time (e.g., current time) social network state information (e.g., settings, preferences, connections, etc.). For example, when a user generates a post in the time-based session, the post may be distributed to those connections of the user present within the social graph of the user at the given instance of time, which may be different than the current state of the social graph of the user. Furthermore, the distribution of the post to the contacts of the user may be according to one or more settings and/or preferences regarding the distribution of posts the were in place (or absent) at the instance of time, which may be different from the current settings and/or preferences of the user. In one example, however, the posts may not be distributed to one or more contacts of the user within the social graph of the user at the given instance of time which are no longer within the social graph of the user for privacy reasons or user preferences of the contacts which have been changed since the instance of time. In yet another example, where certain changes to system settings, or the social networking service have occurred, those changes may effect the manner in which the activity of the user is performed.

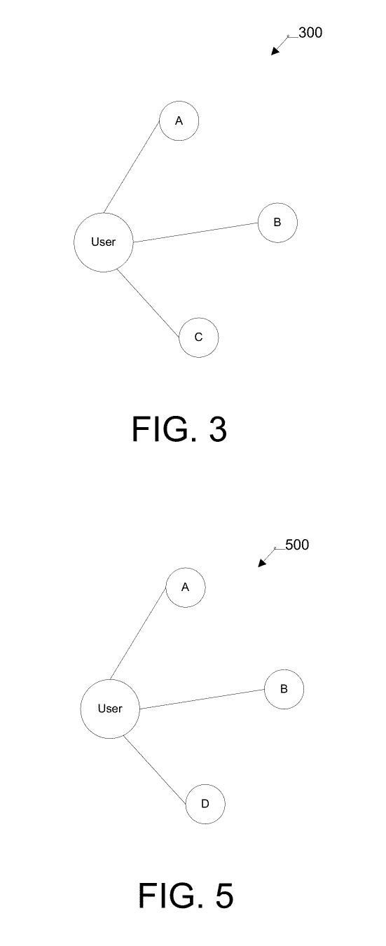

FIG. 3 illustrates an example social graph 300 of a user at a first instance of time (e.g., the current time). As shown, the social graph illustrates the user being connected to contacts A, B and C. The connections represent the social graph of the user at the current time. It should be noted that the social graph is illustrated as an example, and that the connections within a social graph may be represented in different ways in accordance with the systems and methods described herein. A social graph may provide associations between a user and one or more other users and/or groups of users.

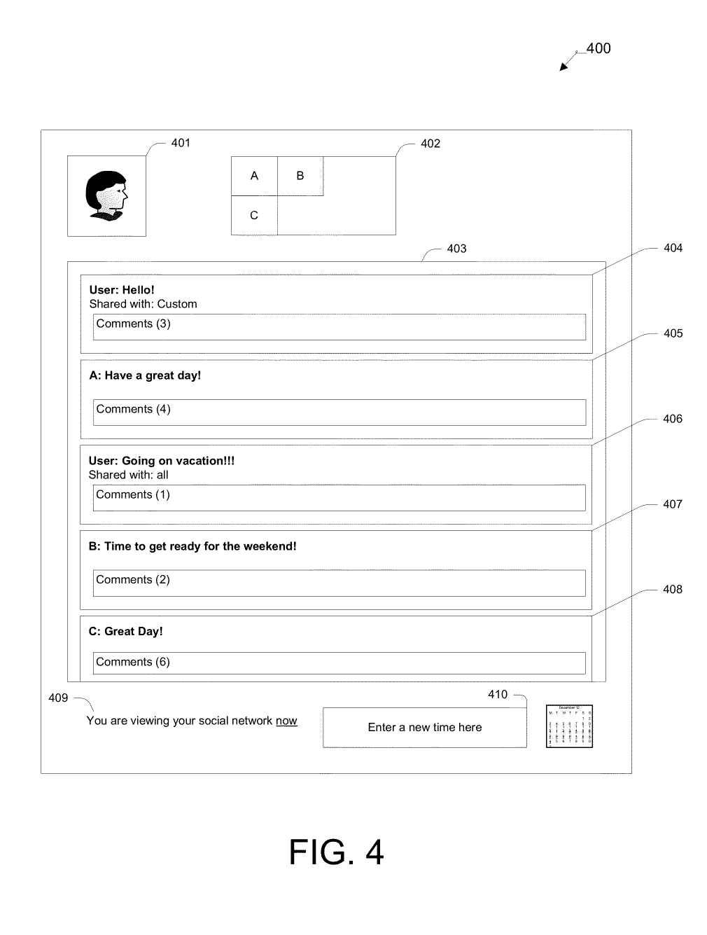

FIG. 4 illustrates an example graphical user interface displaying a social networking page 400 displayed to the user and associated with a social networking session at the first instance of time (e.g., current time). The social networking page 400 includes a photo 401 of the user. A contacts area 402 displays one or more contacts or groups associated with the user within a social graph. The contacts area 402 lists the contacts of the user included within social graph 300 associated with the social networking session as of the first instance of time (current time). A stream area 403 is provided displaying one or more conversations between the user and one or more contacts of the user. The stream area 403 includes posts 404 and 406 from the user being shared with various contacts (e.g., according to preferences of the user at the given instance of time), as well as posts 405, 407, 408 from the contacts of the user. As illustrated, according to the settings and/or preferences of the user, the post 404 is shared with a custom selection of contacts of the user (e.g., one or more users or groups specifically designated), while post 406 is shared with all contacts of the user, which include contacts A, B and C. A time indicator area 409 is displayed indicating the instance of time associated with the social networking session being displayed to the user, here the current time displayed as “now”. A time selector 410 is provided, allowing the user to generate a new social networking session at a new instance of time.

FIG. 5 illustrates a social graph 500 of the user at a second instance of time. In one example, the second instance of time may refer to an instance of time other than the current time selected by the user (e.g., Jan. 1, 2012). The social graph of the user includes contacts A, B and D. The contacts of the user refer to those contacts associated with the user at the second instance of time (Jan. 1, 2012). It should be noted that the social graph is illustrated as an example, and that the connections within a social graph may be represented in different ways in accordance with the systems and methods described herein. A social graph may provide associations between a user and one or more other users and/or groups of users.

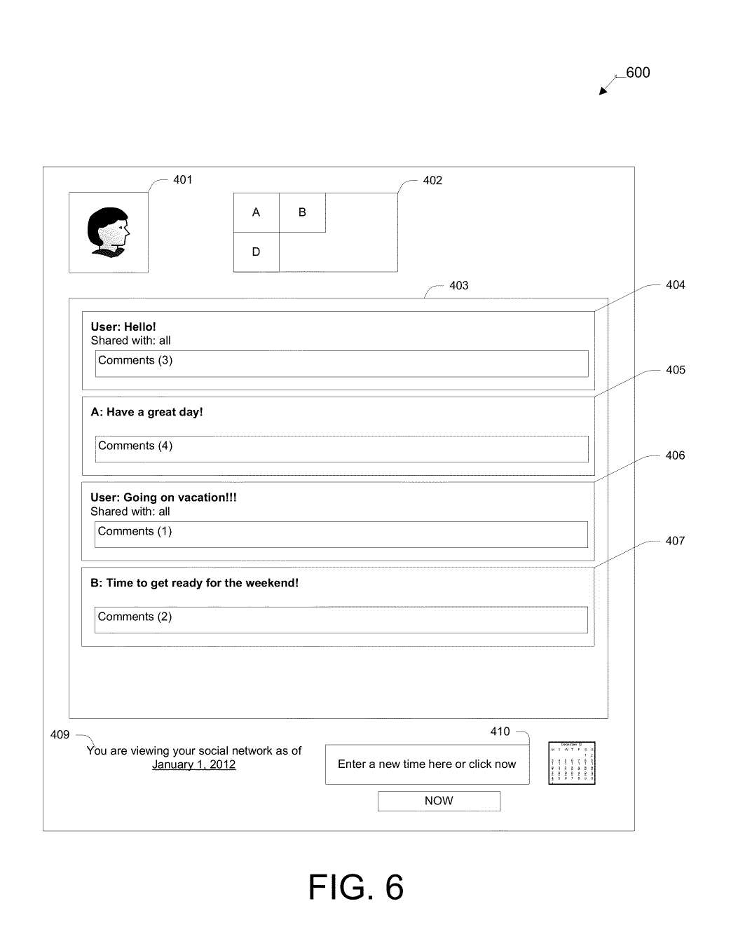

FIG. 6 illustrates an example graphical user interface 600 displaying a social networking page 600 displayed to the user and associated with a social networking session at the second instance of time. The social networking page 600 includes the photo 401 of the user. The contacts area 402 displays one or more contacts or groups associated with the user within a social graph. The contacts area 402 lists the contacts of the user included within social graph 500 associated with the current social networking session. In one example, as illustrated in FIG. 6, contact D may be included in the listing of contacts of the user. In other embodiments, contact D may be eliminated from the listing of contacts presented in contacts area 402 for one or more reasons (e.g., privacy reasons, system settings, user preferences). The stream area 403 includes posts 404 and 406 from the user being shared with various contacts, according to preferences of the user at the second instance of time, as well as posts 405 and 408 from the contacts of the user. As illustrated, according to the settings and/or preferences of the user at the second instance of time, the post 404 is shared with all contacts of the user which now include contacts A, B and D. Post 406 is similarly shared with all contacts of the user, which now includes contacts A, B and D. Thus, posts of the user are no longer shared with contact C. Any new posts by the user, while the user is within the social networking session at this specific instance of time, will be shared with contacts A, B and D and will not be shared with contact C. In other embodiments, the posts 404 and 406 may not be displayed to contact D, for example, for one or more reasons (e.g., privacy reasons, system settings, user preferences). Post 408, which was previously displayed, is now removed from the user's stream 403, since at the specific instance of time associated with this session C is no longer a contact of the user. The time selection mechanism 409 provides information regarding the instance of time associated with the social networking session being displayed to the user, here Jan. 1, 2012. The time selector 410 is provided, allowing the user to generate a new social networking session at a new instance of time or to go back to the current time shown as “now”.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

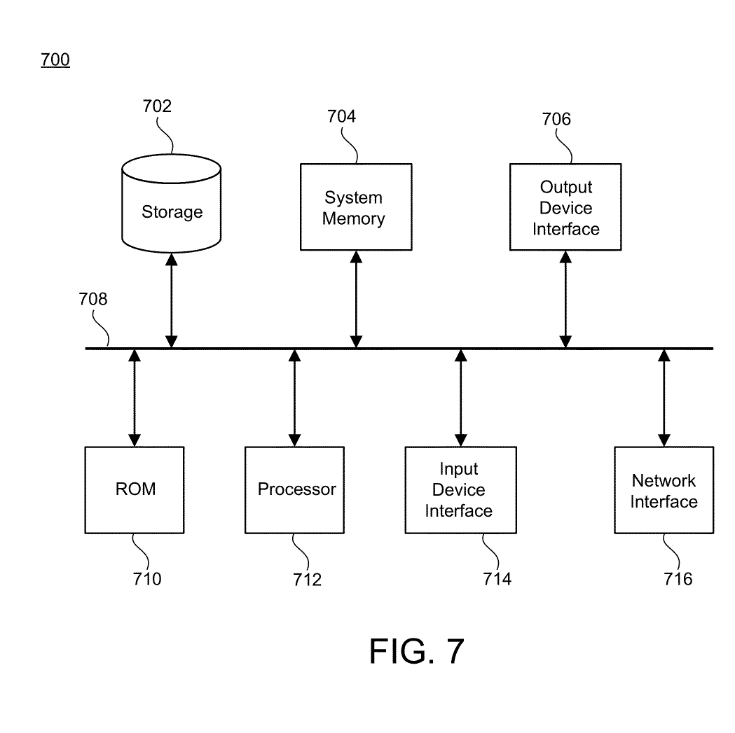

FIG. 7 conceptually illustrates an electronic system with which some implementations of the subject technology are implemented. Electronic system 700 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 700 includes a bus 708, processing unit(s) 712, a system memory 704, a read-only memory (ROM) 710, a permanent storage device 702, an input device interface 714, an output device interface 706, and a network interface 716.

Bus 708 collectively represents all system, peripheral, and chipset buses that communicatively connect the numerous internal devices of electronic system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. Some implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such a random access memory. System memory 704 stores some of the instructions and data that the processor needs at runtime. In some implementations, the processes of the subject disclosure are stored in system memory 704, permanent storage device 702, and/or ROM 710. For example, the various memory units include instructions for facilitating social networking interaction across a time axis. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to the electronic system. Input devices used with input device interface 714 include, for example, alphanumeric keyboards and pointing devices (also called “cursor control devices”). Output device interfaces 706 enables, for example, the display of images generated by the electronic system 700. Output devices used with output device interface 706 include, for example, printers and display devices, such as cathode ray tubes (CRT) or liquid crystal displays (LCD). Some implementations include devices such as a touchscreen that functions as both input and output devices.

Finally, as shown in FIG. 7, bus 708 also couples electronic system 700 to a network (not shown) through a network interface 716. In this manner, the computer can be a part of a network of computers (such as a local area network (“LAN”), a wide area network (“WAN”), or an Intranet, or a network of networks, such as the Internet. Any or all components of electronic system 700 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

What is claimed is:

1. A computer-implemented method comprising:
receiving an indication of a request from a user to generate a time-based social networking session associated with a social networking service;
determining an instance of time associated with the request, the instance of time being distinct from the current time;
identifying social network state information corresponding to the instance of time, the social network state information including social graph information regarding the state of a social graph at the given instance of time;
generating a social networking session according to the social network state information, the social networking session providing the user with a social networking experience according to the state of the social network of the user at the instance of time.

2. The method of claim 1, the social graph information comprising a snap shot of the at least one social graph at an instance of time, the instance of time being proximate to the instance of time.

3. The method of claim 1, the social graph information comprising event information corresponding to one or more changes or modifications of the connections between the user and one or more other users of the social networking service within the social graph.

4. The method of claim 1, the social graph information comprising information corresponding to one or more user connections within the social graph generated at a point before the instance of time.

5. The method of claim 1, the social network state information further comprising one or more user preferences or settings regarding the social networking service specified by the user at the instance of time.

6. The method of claim 1, wherein the generating a social networking experience comprises:
generating a social graph according to the social graph information corresponding to the connections between the user and one or more other users of the social networking service at the instance of time.

7. The method of claim 1, The method of claim 1, further comprising:
providing the social networking experience for display to the user, in response to the request.

8. The method of claim 7, further comprising:
receiving an indication of user activity at the social networking session; and
performing the user activity according to the social network state information.

9. The method of claim 8, wherein performing the user activity according to the social network state information causes the activity to be performed according to one or more of the setting, preferences or the social graph of the user at the instance of time.

10. The method of claim 1, wherein the social networking session is further generated based on one or more current privacy information.

11. The method of claim 10, wherein the privacy information provides one or more modifications to the social network state information according to privacy modifications made after the instance of time.

12. A system comprising:
one or more processors; and
a machine-readable medium comprising instructions stored therein, which when executed by the processors, cause the processors to perform operations comprising:
receiving a request from a user a social networking service to generate a time-based social networking session corresponding to an instance of time different from the current time, the social networking service maintaining a social graph corresponding to the user;
identifying social network state information corresponding to the social network of the user at the instance of time, the social network state information including social graph information regarding a social graph representing connections between the user and one or more other users of the social networking service;
generating a social networking session according to the social network state information including generating the state of the social graph at the instance of time, the social networking session providing the user with a social networking experience according to the state of the social graph of the user at the instance of time.

13. The system of claim 12, the social graph information comprising a snap shot of the social graph at an instance of time, the instance of time being proximate to the instance of time.

14. The system of claim 12, the social graph information comprising events corresponding to one or more changes or modifications with respect to the social graph.

15. The system of claim 12, the social graph information comprising one or more connections within the social graph generated between the user and one or more other users of the social networking service up to the instance of time.

16. The system of claim 12, the social network state information further comprising one or more user preferences or settings regarding the social networking service at the instance of time.

17. The system of claim 12, wherein the generating a social networking experience comprises:
generating a social graph according to the social network state information corresponding to connections between the user and one or more other users of the social networking service at the instance of time.

18. The system of claim 12, the operations further comprising:
providing the social networking session for display to the user, in response to the request;
receiving an indication of user activity with respect to the social networking session; and
performing the user activity according to the social network state information such that the activity is performed with respect to the state of the social network of the user at the instance of time.

19. A machine-readable medium comprising instructions stored therein, which when executed by a machine, cause the machine to perform operations comprising:
receiving a request from a user at a social networking service to generate a time-based social networking session corresponding to an instance of time at the social networking service, the social networking service maintaining a social graph associated with the user, the social graph maintaining connections between the user and one or more other users of the social networking service;
identifying social network state information corresponding to the instance of time, the social network state information including social graph information regarding the social graph and information regarding one or more user preferences and setting at the instance of time, the social graph information providing information regarding the connections between the user and one or more users associated with the user at the instance of time;
generating a social networking session according to the social network state information, the social networking session providing the user with a social networking experience according to the state of the social network of the user at the instance of time.

20. The machine readable-medium of claim 19, the operations further comprising:
providing the social networking experience for display to the user, in response to the request;
receiving an indication of user activity at the social networking service; and
performing the user activity according to the social network state information.
